(19) United States
(12) Patent Application Publication
(10) Pub. No.: US 2019/0188574 A1
(43) Pub. Date: Jun. 20, 2019

(54) GROUND TRUTH GENERATION FRAMEWORK FOR DETERMINATION OF ALGORITHM ACCURACY AT SCALE

(71) Applicant: General Electric Company, Schenectady, NY (US)

(72) Inventors: Hari Menon, San Ramon, CA (US); Marisa Lucht, Franklin, WI (US); Brian Nguyen, State Collage, PA (US); Andrew Lombardi, Berkeley, CA (US)

(21) Appl. No.: 15/845,325

(22) Filed: Dec. 18, 2017

(51) Int. Cl. G06N 5/00; G06N 99/00

(52) U.S. Cl. CPC G06N 5/006; G06K 9/6262; G06N 99/005

(57) ABSTRACT

The example embodiments are directed to a system and method for generating ground truth for determination of algorithm accuracy at scale. In one example, the method includes receiving raw data from at least one data source, performing pre-processing on the raw data, obtaining first information for generating ground truth data by applying a machine learning algorithm to the pre-processed raw data, obtaining second information for generating ground truth data by applying a signal processing algorithm to the pre-processed raw data, generating ground truth data based on matches between the first information and the second information, and determining accuracy of a source algorithm using the generated ground truth data.

### BACKGROUND

Machine and equipment assets are engineered to perform particular tasks as part of a business process. For example, assets can include, among other things and without limitation, industrial manufacturing equipment on a production line, drilling equipment for use in mining operations, wind turbines that generate electricity on a wind farm, transportation vehicles, and the like. As another example, assets may include devices that aid in diagnosing patients such as imaging devices (e.g., X-ray or MRI systems), monitoring equipment, and the like. The design and implementation of these assets often takes into account both the physics of the task at hand, as well as the environment in which such assets are configured to operate.

Low-level software and hardware-based controllers have long been used to drive machine and equipment assets. However, the rise of inexpensive cloud computing, increasing sensor capabilities, and decreasing sensor costs, as well as the proliferation of mobile technologies, have created opportunities for creating novel industrial and healthcare based assets with improved sensing technology and which are capable of transmitting data that can then be distributed throughout a network. As a consequence, there are new opportunities to enhance the business value of some assets through the use of novel industrial-focused hardware and software.

Data science has become an important component of enterprise data management. Data science algorithms are often developed, for example, for analysis purposes and deployed at scale, allowing for rapid increase in insights for enterprises. Typically, algorithms are developed to analyze a variety of industrial use cases, such as detecting events, processes, and states of industrial equipment. As data volumes continue to grow and deep learning drives the creation of increasingly complex algorithms, extracting valuable intelligence and knowledge becomes increasingly challenging.

Conventionally, in the industrial context, generating ground truth data to test algorithm accuracy for unlabeled datasets often require secondary measurements. Examples of secondary measurements include using a measurement device to label the data generated or visually inspecting raw data to identify and manually label the data. For example, a person could be on-site when a sample of data is being collected and can keep track of the events, processes, or states that the algorithm should be detecting, or the person could use more accurate measurement devices (e.g., sensors or controllers), that would precisely measure the event, process, or state of the asset being analyzed. Both of these methods would be expensive to implement, especially at scale in industry. Alternatively, a person could manually visualize the data being collected with plots or charts, and inspect the data to determine where events are occurring. This visual inspection is rather time-consuming, labor intensive, and not feasible to implement at scale.

What is needed is system and method capable of providing a streamlined, automated method to develop ground truth results for algorithm development and testing at scale.

### SUMMARY

Embodiments described herein improve upon the prior art by providing systems and methods which enable the automated generation of ground truth for determining algorithm accuracy at scale.

The disclosed embodiments relate to a ground truth generation framework for determination of algorithm accuracy at scale. The disclosed embodiments include generating ground truth results by performing pre-processing on raw data from a data source, applying various models to the pre-processed raw data, and performing multi-dimensional validation using the output from the various models. The disclosed embodiments further include compiling and comparing the ground truth results to timestamps of results of an original source algorithm being developed and performing an accuracy determination.

A technical advantage of the ground truth generation framework is improved efficiency of accuracy checking during algorithm development. By virtue of a strategy that compares algorithm results to the ground truth that the disclosed process generates, users (e.g., developers) are able to pinpoint strengths and weaknesses of each algorithm. Also, in addition to providing structure as to how to verify an algorithm, the disclosed process provides flexibility for customization of the framework to utilize other types of algorithms.

A commercial advantage of the ground truth generation framework is that testing at scale becomes feasible and reliable. Rather than manually detecting ground truth, automating it through this described approach reduces the time spent in testing and verification, and ultimately allows a product to be brought to market faster. In addition, the described approach to generate ground truth results allows for flexibility to follow the market. For example, if another algorithm is developed for the product, the disclosed process may need to be adjusted to the specificities of the new algorithm. Advantageously, through the described approach, costly new equipment would not need to be installed to verify the new algorithm's accuracy. Ultimately, this acceleration of productization allows for flexibility to meet customer needs while simultaneously saving time and money for both the developers of the algorithm and the customer.

Other features and aspects may be apparent from the following detailed description taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is an overall diagram of a cloud computing system for industrial software and hardware in accordance with an example embodiment.

FIG. 2 is a block flow diagram illustrating a process for determination of algorithm accuracy in accordance with an example embodiment.

FIG. 3 is a simplified flow diagram illustrating a process for determination of algorithm accuracy in accordance with an example embodiment.

FIG. 4 is a set of related diagrams illustrating a multi-dimensional validation use case in accordance with an example embodiment.

FIG. 5 is a block diagram of a computing system in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The disclosed embodiments utilize, among others, data exploration, data pre-processing, machine learning, signal processing, and multi-dimensional validation/verification techniques to provide an outline to produce ground truth results. For the purposes of this disclosure, “ground truth” data refers to information that can be used as a reference to compare an algorithm result to.

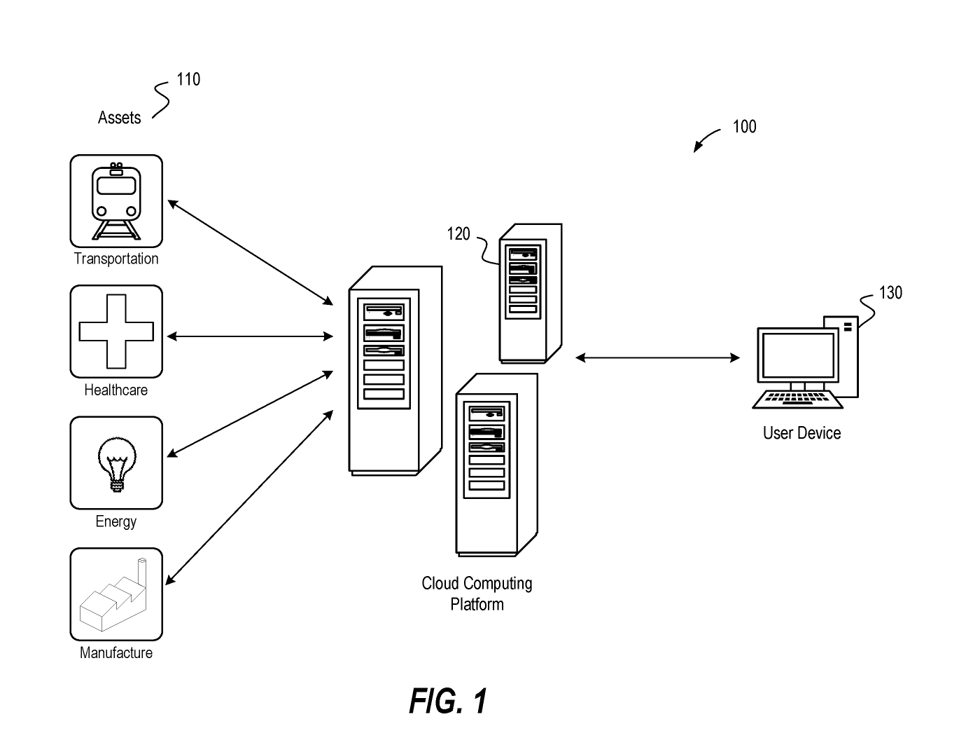

FIG. 1 illustrates a cloud computing system 100 for industrial software and hardware in accordance with an example embodiment. Referring to FIG. 1, the system 100 includes a plurality of assets 110 which may be included within an Industrial Internet of Things (IIoT) and which may transmit raw data to a source such as cloud computing platform 120 where it may be stored and processed. It should also be appreciated that the cloud platform 120 in FIG. 1 may be replaced with or supplemented by a non-cloud platform such as a server, an on-premises computing system, and the like. Assets 110 may include hardware/structural assets such as machine and equipment used in industry, healthcare, manufacturing, energy, transportation, and the like. It should also be appreciated that assets 110 may include software, processes, resources, and the like.

The data transmitted by the assets 110 and received by the cloud platform 120 may include data that is being input to hardware and/or software deployed on or in association with the assets 110, raw time-series data output as a result of the operation of the assets 110, and the like. Data that is stored and processed by the cloud platform 120 may be output in some meaningful way to user devices 130. In the example of FIG. 1, the assets 110, cloud platform 120, and user devices 130 may be connected to each other via a network such a public network (e.g., Internet), a private network, a wired network, a wireless network, etc. User devices 130 may interact with software hosted by and deployed on the cloud platform 120 in order to receive data from and control operation of the assets 110.

It should be appreciated that the system 100 is merely an example and may include additional devices and/or one of the devices shown may be omitted.

According to various aspects, software applications that can be used to enhance or otherwise modify the operating performance of an asset 110 may be hosted by the cloud platform 120 and may operate on the asset 110. For example, software applications may be used to optimize a performance of the assets 110 or data coming in from the asset 110. As another example, the software applications may analyze, control, manage, or otherwise interact with the asset 110 and components (software and hardware) thereof A user device 130 may receive views of data or other information about the asset 110 as the data is processed via one or more applications hosted by the cloud platform 120. For example, the user device 130 may receive graph-based results, diagrams, charts, warnings, measurements, power levels, and the like.

In this example, an asset management platform (AMP) can reside within or be connected to the cloud platform 120, in a local or sandboxed environment, or can be distributed across multiple locations or devices and can be used to interact with the assets 110. The AMP can be configured to perform functions such as data acquisition, data analysis, data exchange, and the like, with local or remote assets 110, or with other task-specific processing devices. For example, the assets 110 may be an asset community (e.g., turbines, healthcare, power, industrial, manufacturing, mining, oil and gas, elevators, etc.) which may be communicatively coupled to the cloud platform 120 via one or more intermediate devices such as a stream data transfer platform, database, or the like.

Information from the assets 110 may be communicated to the cloud platform 120. For example, external sensors can be used to sense information about a function of an asset, or to sense information about an environment condition at or around an asset, a worker, a downtime, a machine or equipment maintenance, and the like. The external sensor can be configured for data communication with the cloud platform 120 which can be configured to store the raw sensor information and transfer the raw sensor information to the user devices 130 where it can be accessed by users, applications, systems, and the like, for further processing. Furthermore, an operation of the assets 110 may be enhanced or otherwise controlled by a user inputting commands though an application hosted by the cloud platform 120 or other remote host platform such as a web server. The data provided from the assets 110 may include time-series data or other types of data associated with the operations being performed by the assets 110.

In some embodiments, the cloud platform 120 may include a local, system, enterprise, or global computing infrastructure that can be optimized for industrial data workloads, secure data communication, and compliance with regulatory requirements. The cloud platform 120 may include a database management system (DBMS) for creating, monitoring, and controlling access to data in a database coupled to or included within the cloud platform 120. The cloud platform 120 can also include services that developers can use to build or test industrial or manufacturing-based applications and services to implement IIoT applications that interact with assets 110.

For example, the cloud platform 120 may host an industrial application marketplace where developers can publish their distinctly developed applications and/or retrieve applications from third parties. In addition, the cloud platform 120 can host a development framework for communicating with various available services or modules. The development framework can offer developers a consistent contextual user experience in web or mobile applications. Developers can add and make accessible their applications (services, data, analytics, etc.) via the cloud platform 120. Also, analytic software may analyze data from or about a manufacturing process and provide insight, predictions, and early warning fault detection.

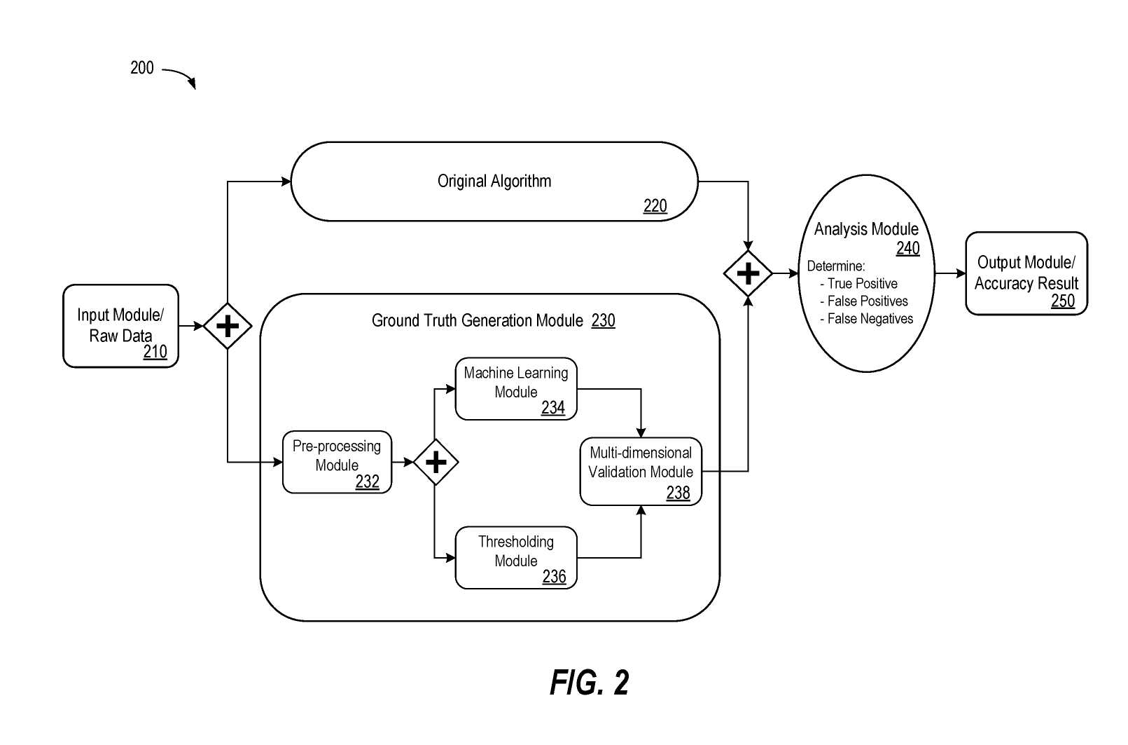

Reference is now made to FIGS. 2 through 4, which will be discussed together. FIG. 2 is a block flow diagram illustrating an exemplary process 200 according to some embodiments. For example, process 200 may be performed by the software and/or the system described herein. Process 200 provides a structure to reach ground truth results that can be compared to algorithm outputs to determine accuracies (e.g., evaluating the accuracy of an original source algorithm).

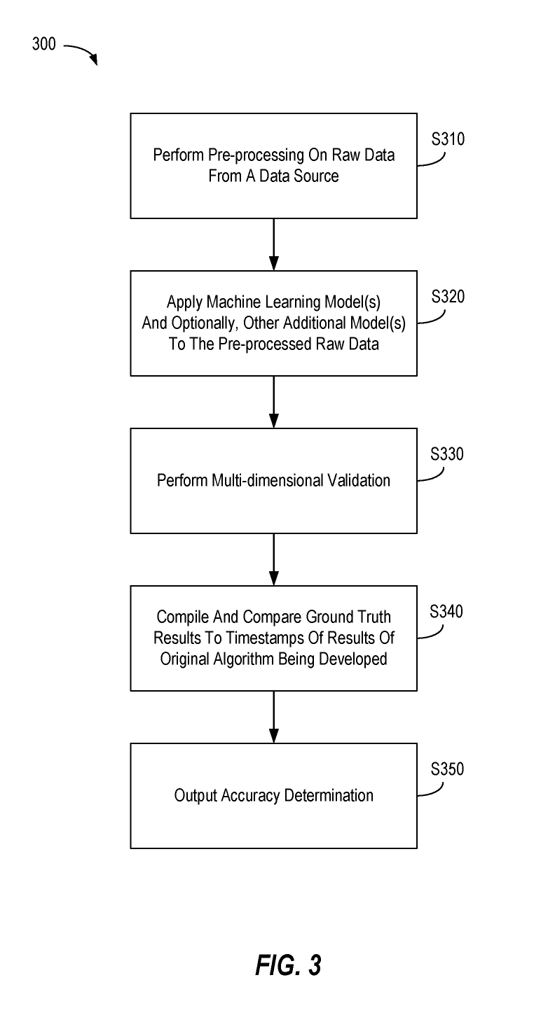

FIG. 3 is a simplified flow diagram illustrating steps of a method 300 according to some embodiments.

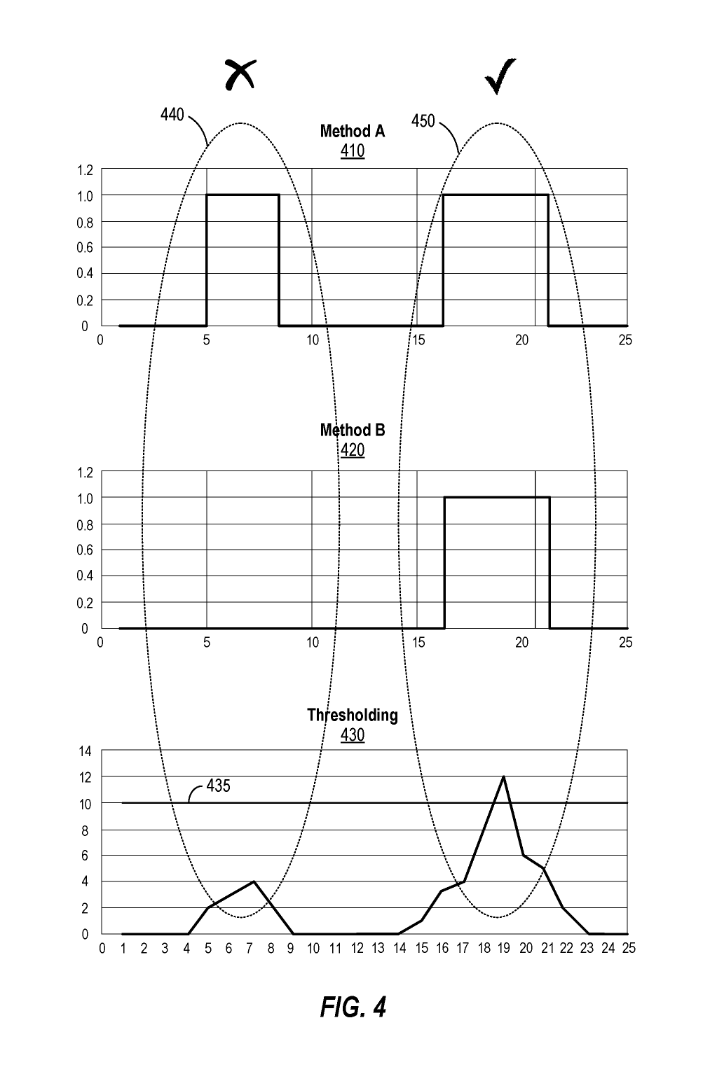

FIG. 4 is a set of related diagrams 410, 420, 430 illustrating a use case according to some embodiments. More specifically, FIG. 4 illustrates a use case for machine learning 234, thresholding 236, and multi-dimensional validation 238 in accordance with FIG. 2.

Turning to FIG. 2, the first step in the process 200 is to understand the data being used and the algorithm being developed. By evaluating how many viable sources of data are available, a user (e.g., data scientist) utilizing the process can determine how to adjust the framework to fit specific needs. Gathering an understanding of how an existing algorithm detects data and how different sources of data record the algorithm output of an asset in various ways is beneficial to later determining which data sources and machine learning techniques to use.

Once an inventory of viable data sources is established, ground truth generation may begin. Ground truth data is generated by ground truth generation module 230. In an example embodiment shown in FIG. 2, ground truth generation module 230 includes pre-processing module 232, machine learning module 234, thresholding module 236, and multi-dimensional validation module 238.

Turning also to FIG. 3, at 5310, raw data from a data source 210 (e.g., raw sensor data) is collected and pre-processed (e.g., cleaned) such that it is suitable for use in a model. For example, pre-processing module 232 processes the raw data to remove unwanted artifacts and ensure that the data is complete and in a form that facilitates quality results from a model (e.g., machine learning model).

Once the data has been pre-processed, the next step at 5320 is to analyze which machine learning model(s) would be the best fit for validation (cross-check) in a specific problem. In one example, machine learning module 234 may apply a K-means algorithm as a checking algorithm to check against an original algorithm 220 (e.g., a Hidden Markov Model (HMM) algorithm), and if the results of the algorithms matched or were in agreement with each other, a marked event is determined to be accurate (e.g., “true positive” result).

The chosen model(s) may not be entirely accurate, and therefore, in some embodiments, other methods (e.g., additional models) may be included at 5320.

Multi-dimensional validation is performed at 5330 (e.g., by multi-dimensional validation module 238) to generate ground truth results. In the use case of multi-dimensional validation shown in FIG. 4, machine learning module 234 implements independent machine learning algorithms in Method A 410 and Method B 420 to detect the occurrence of an event. Here, two events 440, 450 are detected in Method A, but only one event 450 is detected in Method B. In order to validate whether the extra event detected in Method A is a true event, process 300 utilizes an additional validation method (e.g., thresholding 430). Thresholding refers to a signal processing technique of marking whether or not the data is greater than a certain value (e.g., threshold).

As can be seen from graph 430, the data does not surpass threshold 435. Therefore, the first event 440 detected in Method A is determined to be inaccurate (e.g., “false positive” result) and should not be included in the final ground truth results. In some embodiments, the threshold may be determined by taking the value of an extreme quantile (e.g., 99.5%).

In this way, thresholding module 236 may further verify whether a marked event by a first model (e.g., first event marked by Method A) is actually correct. In addition, thresholding may be used to raise flags when it appears that an event is occurring, but no event was marked (e.g., “false negative” result). In one example, thresholding module 236 may use rolling averages and root mean square (RMS) to analyze the data. As can be seen in FIG. 4, additional model(s) applied at S320 provide further insights into the meaning of the data.

In turn, at S340, analysis module 240 compiles the results (e.g., ground truth results) from machine learning module 243, thresholding module 236, and optionally, other additional models from modules not specifically shown, and compares the result with the timestamps of the results of the original working algorithm 220 being developed (e.g., specific events occurring at particular instances in time). In some embodiments, analysis module 240 identifies “true positive”, “false positive”, and “false negative” results. From this information, output module 250 determines the accuracy of original algorithm 220 being developed, and the accuracy determination is output at S350. In some embodiments, an Fi score (also F-score or F-measure, which measures accuracy) is determined by pooling all the true positive, false positive, and false negative results from analysis module 240.

As used herein, the term “true positive” refers to a result which classifies an occurrence of an event correctly as an event that has occurred (e.g., original algorithm detects an event and ground truth indicates that the event occurred). As used herein, the term “false positive” refers to a result which classifies an occurrence of an event incorrectly as an event that has occurred (e.g., original algorithm detects an event and ground truth indicates that the event did not occur). Likewise, a “false negative” refers to a result which classifies an occurrence of an event incorrectly as an event that has not occurred (e.g., original algorithm detects no event and ground truth indicates that an event occurred).

It will be appreciated by those skilled in the art that other suitable data science models may be used by ground truth generation module 230, and the disclosed embodiments are not limited to any particular model or algorithm, and may vary as necessary or desired.

Further, it is contemplated that actual/known ground truth information (e.g., reality, also referred to as “ultimate ground truth”) may become available. In such embodiments, ground truth generated by generation module 230 may be replaced by the ultimate ground truth, and the remaining process for accuracy checks (e.g., S340-S350) would occur as described above. For example, a controller on an asset recording actual events outputs actual ground truth information, and this output information (e.g., controller data) may be used in place of the ground truth information generated by generation module 230.

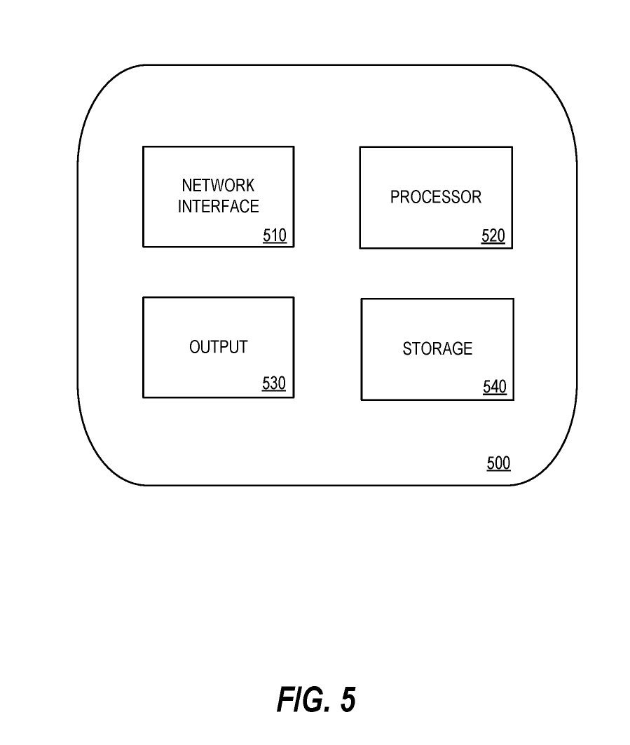

FIG. 5 is a block diagram of a computing system 500 for generating ground truth for determination of algorithm accuracy in accordance with an example embodiment. For example, the computing system 500 may be a database, cloud platform, streaming platform, user device, and the like. As a non-limiting example, the computing system 500 may be the cloud platform 120 shown in FIG. 1. In some embodiments, the computing system 500 may be distributed across multiple devices. Also, the computing system 500 may perform the methods of FIGS. 2 and 3. Referring to FIG. 5, the computing system 500 includes a network interface 510, a processor 520, an output 530, and a storage device 540 such as a memory. Although not shown in FIG. 5, the computing system 500 may include other components such as a display, an input unit, a receiver, a transmitter, an application programming interface (API), and the like, all of which may be controlled or replaced by the processor 520.

The network interface 510 may transmit and receive data over a network such as the Internet, a private network, a public network, and the like. The network interface 510 may be a wireless interface, a wired interface, or a combination thereof. The processor 520 may include one or more processing devices each including one or more processing cores. In some examples, the processor 520 is a multicore processor or a plurality of multicore processors. Also, the processor 520 may be fixed or it may be reconfigurable. The output 530 may output data to an embedded display of the computing system 500, an externally connected display, a display connected to the cloud, another device, and the like. The storage device 540 is not limited to a particular storage device and may include any known memory device such as RAM, ROM, hard disk, and the like, and may or may not be included within the cloud environment. The storage 540 may store software modules or other instructions which can be executed by the processor 520 to perform the methods described herein. Also, the storage 540 may store software programs and applications which can be downloaded and installed by a user. Furthermore, the storage 540 may store and the processor 520 may execute an application marketplace that makes the software programs and applications available to users that connect to the computing system 500.

As will be appreciated based on the foregoing specification, the above-described examples of the disclosure may be implemented using computer programming or engineering techniques including computer software, firmware, hardware or any combination or subset thereof Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computer-implemented method comprising:
receiving raw data from at least one data source;
performing pre-processing on the raw data;
obtaining first information for generating ground truth data by applying a machine learning algorithm to the pre-processed raw data;
obtaining second information for generating ground truth data by applying a signal processing algorithm to the pre-processed raw data;
generating ground truth data based on matches between the first information and the second information; and
determining accuracy of a source algorithm using the generated ground truth data.

2. The computer-implemented method of claim 1, further comprising:
applying a source algorithm to the raw data to produce a dataset of timestamped events;
comparing the generated ground truth data to the dataset of timestamped events from the source algorithm; and
determining accuracy of the source algorithm based on results of the comparison.

3. The computer-implemented method of claim 1, further comprising obtaining additional information for generating the ground truth data by applying one or more additional algorithms to the pre-processed raw data.

4. The computer-implemented method of claim 1, further comprising, adding, changing, or removing one or more algorithms used for generating the ground truth data prior to generating the ground truth data.

5. The computer-implemented method of claim 2, wherein determining accuracy of the source algorithm includes determining an F₁ score by compiling results of the comparison between the generated ground truth data and the dataset of timestamped events from the source algorithm.

6. The computer-implemented method of claim 5, wherein the results of the comparison include true positive, false positive, and false negative judgements.

7. The computer-implemented method of claim 1, further comprising:
replacing the generated ground truth data with known ground truth data; and
determining accuracy of the source algorithm using the known ground truth data.

8. The computer-implemented method of claim 1, wherein the machine learning algorithm is a clustering algorithm.

9. The computer-implemented method of claim 1, wherein the signal processing algorithm applies a threshold to the pre-processed raw data as a criterion to identify whether an event occurred at the least one data source during an associated time interval.

10. A computing system comprising:
a memory storing instructions; and
a processor configured to execute the instructions, wherein the executed instructions cause the processor to:
receive collected data from at least one data source;
perform pre-processing on the collected data;
obtain first information for generating ground truth data by applying a first algorithm to the pre-processed collected data;
obtain second information for generating ground truth data by applying a second algorithm to the pre-processed collected data;
generate ground truth data based on matches between the first information and the second information; and
determine accuracy of a source algorithm using the generated ground truth data.

11. The computing system of claim 10, wherein the processor is further configured to:
apply a source algorithm to the collected data to produce a dataset of timestamped events;
compare the generated ground truth data to the dataset of timestamped events from the source algorithm; and
determining accuracy of the source algorithm based on results of the comparison.

12. The computing system of claim 10, wherein the processor is further configured to obtain additional information for generating the ground truth data by applying one or more additional algorithms to the pre-processed collected data.

13. The computing system of claim 10, wherein the first algorithm is based on a machine learning model and the second algorithm is based on a thresholding model.

14. The computing system of claim 10, wherein the first algorithm and the second algorithm are different algorithms.

15. The computing system of claim 10, wherein the processor is further configured to add, change, or remove one or more algorithms used for generating the ground truth data prior to generating the ground truth data.

16. The computing system of claim 11, wherein determining accuracy of the source algorithm includes determining an F₁ score by compiling results of the comparison between the generated ground truth data and the dataset of timestamped events from the source algorithm.

17. The computing system of claim 16, wherein the results of the comparison include true positive, false positive, and false negative judgements.

18. The computing system of claim 10, wherein the processor is further configured to:
replace the generated ground truth data with known ground truth data; and
determining accuracy of the source algorithm using the known ground truth data.

19. A non-transitory computer readable medium having stored therein instructions that when executed cause a computer to perform a method comprising:
receiving raw data from at least one data source;
performing pre-processing on the raw data;
obtaining first information for generating ground truth data by applying a machine learning algorithm to the pre-processed raw data;
obtaining second information for generating ground truth data by applying a signal processing algorithm to the pre-processed raw data;
generating ground truth data based on matches between the first information and the second information; and
determining accuracy of a source algorithm using the generated ground truth data.

20. The non-transitory computer readable medium of claim 19, the method further comprising:
applying a source algorithm to the raw data to produce a dataset of timestamped events;
comparing the generated ground truth data to the dataset of timestamped events from the source algorithm; and
determining accuracy of the source algorithm based on results of the comparison.
